(19) United States
(12) Patent Application Publication
(10) Pub. No.: US 2011/0320733 A1
(43) Pub. Date: Dec. 29, 2011

(54) CACHE MANAGEMENT AND ACCELERATION OF STORAGE MEDIA

(76) Inventors: Steven Ted Sanford, Mountain View, CA (US); Serge Shats, Palo Alto, CA (US); Arkady Rabinov, Cupertino, CA (US)

(21) Appl. No.: 13/153,117

(22) Filed: Jun. 3, 2011

Related U.S. Application Data
(60) Provisional application No. 61/351,740, filed on Jun. 4, 2010.
(60) Provisional application No. 61/445,225, filed on Feb. 22, 2011.

(51) Int. Cl. G06F 12/08

(52) U.S. Cl. 711/135; 711/E12.022

(57) ABSTRACT

Examples of described systems utilize a cache media in one or more computing devices that may accelerate access to other storage media. A solid state drive may be used as the local cache media. In some embodiments, the solid state drive may be used as a log structured cache, may employ multi-level metadata management, may use read and write gating.

### CROSS REFERENCE TO RELATED APPLICATION(S)

This application claims the benefit of Provisional Application Nos. 61/351,740 filed on Jun. 4, 2010, and 61/445,225, filed on Feb. 22, 2011 which applications are incorporated herein by reference, in their entirety, for any purpose.

### TECHNICAL FIELD

Embodiments of the invention relate generally to cache management, and software tools for disk acceleration are described.

### BACKGROUND

As processing speeds of computing equipment have increased, input/output (I/O) speed of data storage has not necessarily kept pace. Without being bound by theory, processing speed has generally been growing exponentially following Moore's law, while mechanical storage disks follow Newtonian dynamics and experience lackluster performance improvements in comparison. Increasingly fast processing units are accessing these relatively slower storage media, and in some cases, the I/O speed of the storage media itself can cause or contribute to overall performance bottlenecks of a computing system. The I/O speed may be a bottleneck for response in time sensitive applications, including but not limited to virtual servers, file servers, and enterprise application servers (e.g. email servers and database applications).

Solid state storage devices (SSDs) have been growing in popularity. SSDs employ solid state memory to store data. The SSDs generally have no moving parts and therefore may not suffer from the mechanical limitations of conventional hard disk drives. However, SSDs remain relatively expensive compared with disk drives. Moreover, SSDs have reliability challenges associated with repetitive writing/erasing of the solid state memory. For instance, wear-leveling may need to be used for SSDs to ensure data is not erased and written to one area significantly more than other areas, which may contribute to premature failure of the heavily used area. Another method of avoiding uneven writing into different SSD locations may be to write random writes sequentially.

SSDs have been used in tiered storage solutions for enterprise systems. FIG. 1 is a schematic illustration of an example computing system 100 including a tiered storage solution. The computing system 100 includes two servers 105 and 110 connected to tiered storage 115 over a storage area network (SAN) 120. The tiered storage 115 includes three types of storage—a solid state drive 122, a fast SCSI drive 124 (typically, SAS), and a relatively slow, high capacity drive 126 (typically, SATA). Each tier 122, 124, 126 of the tiered storage stores a portion of the overall data requirements of the system 100. The tiered storage automatically selects which tier to store data according to the frequency of use of the data and the I/O speed of the particular tier. For example, data that is anticipated to be more frequently used may be stored in the faster SSD tier 122. In operation, read and write requests are sent by the servers 105, 110 to the tiered storage 115 over the storage area network 120. A tiered storage manager 130 receives the read and write requests from the servers 105 and 110. Responsive to a read request, the tiered storage manager 130 ensures data is read from the appropriate tier. Most frequently used data is moved to faster tiers. Less frequently used data is moved to slower tiers. Each tier 122, 124, 126 stores a portion of the overall data available to the computing system 100.

In addition to tiered storage, SSDs can be used as a complete substitute of a hard drive.

Finally, SSDs can be used as a persistent caching device in storage appliances—both NAS and SAN.

### BRIEF DESCRIPTION OF THE DRAWINGS

FIG. 1 is a schematic illustration of an example computing system including a tiered storage solution.

FIG. 2 is a schematic illustration of a computing system 200 arranged in accordance with an example of the present invention.

FIG. 3 is a schematic illustration of a block level filter driver 300 arranged in accordance with an example of the present invention.

FIG. 4 is a schematic illustration of a cache management driver arranged in accordance with an example of the present invention.

FIG. 5 is a schematic illustration of a log structured cache configuration in accordance with an example of the present invention.

FIG. 6 is a schematic illustration of stored mapping information in accordance with examples of the present invention.

FIG. 7 is a schematic illustration of a gates control block and related components arranged in accordance with an example of the present invention.

### DETAILED DESCRIPTION

Certain details are set forth below to provide a sufficient understanding of embodiments of the invention. However, it will be clear to one skilled in the art that some embodiments of the invention may be practiced without various of the particular details. In some instances, well-known software operations and computing system components have not been shown in detail in order to avoid unnecessarily obscuring the described embodiments of the invention.

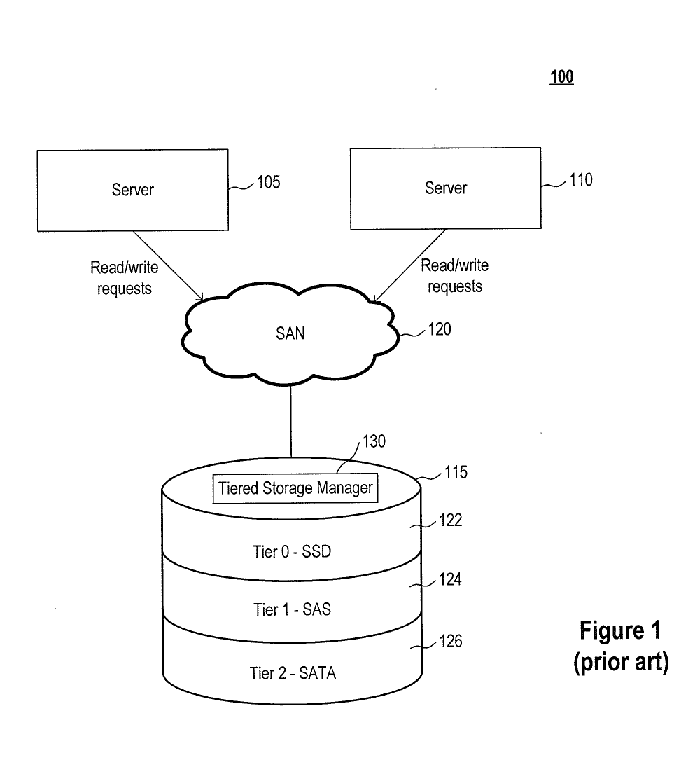

As described above, tiered storage solutions may provide one way of integrating data storage media having different I/O speeds into an overall computing system. However, tiered storage solutions may be limited in that the solution is a relatively expensive, packaged collection of pre-selected storage options, such as the tiered storage 115 of FIG. 1. To obtain the benefits of the tiered storage solution, computing systems must obtain new tiered storage appliances, such as the tiered storage 115. Storage under or over-provisioning is very typical in this case, and represents a waste of resources or a risk of running out of storage.

Embodiments of the present invention, while not limited to overcoming any or all limitations of tiered storage solutions, may provide a different mechanism for utilizing caching devices, which may be implemented using SSDs, in computing systems. The caching devices may be used to accelerate other storage media. Embodiments of the present invention may in some cases be utilized along with tiered storage solutions. SSDs, such as flash memory used in embodiments of the present invention may be available in different forms, including but not limited to, externally or internally attached as solid state disks (SATA or SAS), and direct attached or attached via storage area network (SAN). Also flash memory usable in embodiments of the present invention may be available in form of PCI-pluggable cards or in any other form compatible with an operating system (memory DIMM-like, for instance).

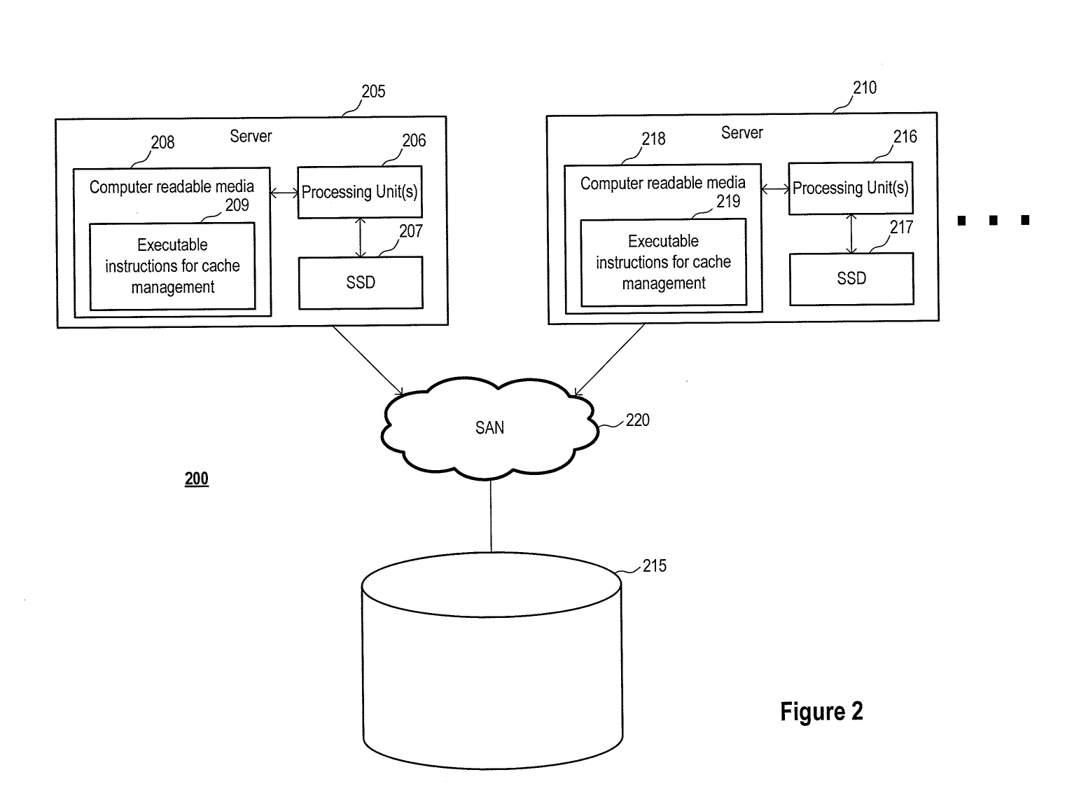

FIG. 2 is a schematic illustration of a computing system 200 arranged in accordance with an example of the present invention. Generally, examples of the present invention include storage media at a server or other computing device that functions as a cache for slower storage media. Server 205 of FIG. 2 includes solid state drive (SSD) 207. The SSD 207 functions as a persistent or non-persistent cache for the storage media 215 that is coupled to the server 205 over storage area network 220. Accordingly, the SSD may be referred to as a “caching device” herein. In other embodiments, other types of storage media may be used to implement a caching device as described herein. In some embodiments, NAS can be used also to attach external storage devices. The server 205 includes processing units 206 and storage media 208, storing local data and executable instructions, specifically, for cache management 209. Storage media or computer readable media as used herein may refer to a single medium or a collection of storage media used to store the described instructions or data. The executable instructions for cache management 209 allow the processing unit(s) 206 to manage the SSD 207 and backend storage media 215 by, for example, appropriately directing read and write requests, as will be described further below. Note that SSDs should be logically connected (e.g. logically belonged) to computing devices. Physically, SSDs can be shared (available for all nodes in cluster) or not-shared (directly attached).

Although a storage area network is shown in FIG. 2, embodiments of the present invention may be used to accelerate storage media available as direct attached storage, over storage area networks, as network attached storage, or any other configuration. Moreover, although the SSDs are shown in FIG. 2 as local to the servers, the caching devices may themselves be available as direct attached storage, or attached over a storage area network.

In the embodiment of FIG. 2, server 210 is also coupled to the shared storage media 215 through the storage area network 220. The server 210 similarly includes an SSD 217, one or more processing unit(s) 216, and computer accessible media 218 including executable instructions for cache management 219. Any number of servers may generally be included in the computing system 200, which may be a server cluster, and some or all of the servers, which may be cluster nodes, may be provided with an SSD and software for cache management. However, the present invention can be used in the clusters without shared storage (share-nothing cluster) or in non-clustered standalone computing system.

By utilizing SSD 207 as a local cache for the backend storage media 215, the faster access time of the SSD 207 may be exploited in servicing cache hits or “lazy writes”. Cache misses or special write requests are directed to the storage media 215. As will be described further below, various examples of the present invention implement a local SSD cache.

The SSD 207 and 217 may be in communication with the respective servers 205 and 210 through any of a variety of communication mechanisms, including, but not limited to, over a SATA, SAS or FC interface, located on a RAID controller and visible to an operating system of the server as a block device, a PCI pluggable flash card visible to an operating system of the server as a block device, or any other mechanism for providing communication between the SSD 207 or 217 and their respective processing unit(s).

Substantially any type of SSD may be used to implement SSDs 207 and 217, including, but not limited to, any type of flash drive. Although described above with reference to FIG. 2 as SSDs 207 and 217, other embodiments of the present invention may implement the local cache, also referred to herein as a “caching device,” using another type of storage media other than solid state drives. In some embodiments of the present invention, the media used to implement the local cache may advantageously have an I/O speed 10 times that of the storage media, such as the storage media 215 of FIG. 2. In some embodiments of the present invention, the media used to implement the local cache may advantageously have a size 1/10 that of the storage media, such as the storage media 215 of FIG. 2. Accordingly, in some embodiments a faster hard drive may be used to implement a local cache for an attached storage device, for example. These performance metrics may be used to select appropriate storage media for implementation as a local cache, but they are not intended to limit embodiments of the present invention to only those which meet the performance metrics. For instance, in some embodiments of the present invention, SSD and backend storage media speed can be identical. In this case the SSD may still help to improve overall storage subsystem performance and/or may allow for a reduction in a number of disk drives without performance degradation.

Moreover, although described above with reference to FIG. 2 as executable instructions 209, 219 stored on a computer accessible media 208, 218, the cache management functionalities described herein may in some embodiments be implemented in firmware or hardware, or combinations of software, firmware, and hardware. Each of the computer accessible media 208, 218 may be implemented using a single medium or a collection of media.

Substantially any computing device may be provided with a local cache and cache management solutions described herein including, but not limited to, one or more servers, storage clouds, storage appliances, workstations, desktops, laptops, or combinations thereof. An SSD, such as flash memory used as a disk cache can be used in a cluster of servers or in one or more standalone server, appliance, workstation, desktop or laptop. If the SSD is used in cluster, embodiments of the present invention may allow the use of the SSD as a distributed cache with mandatory cache coherency across all nodes in the cluster. Cache coherency may be advantageous for SSD locally attached to each node in the cluster. Note that some types of SSD can be attached as locally only (for example, PCI pluggable devices).

By providing a local cache, such as a solid state drive local cache, at the servers 205 and 210, along with appropriate cache management, the I/O speed of the storage media 215 may in some embodiments effectively be accelerated. While embodiments of the invention are not limited to those which achieve any or all of the advantages described herein, some embodiments of solid state drive or other local cache media described herein may provide a variety of performance advantages. For instance, utilizing an SSD as a local cache at a server may allow acceleration of relatively inexpensive shared storage (such as SATA drives). Utilizing an SSD as a transparent (for existing software and hardware layers) local cache at a server may not require any modification in preexisting storage configuration.

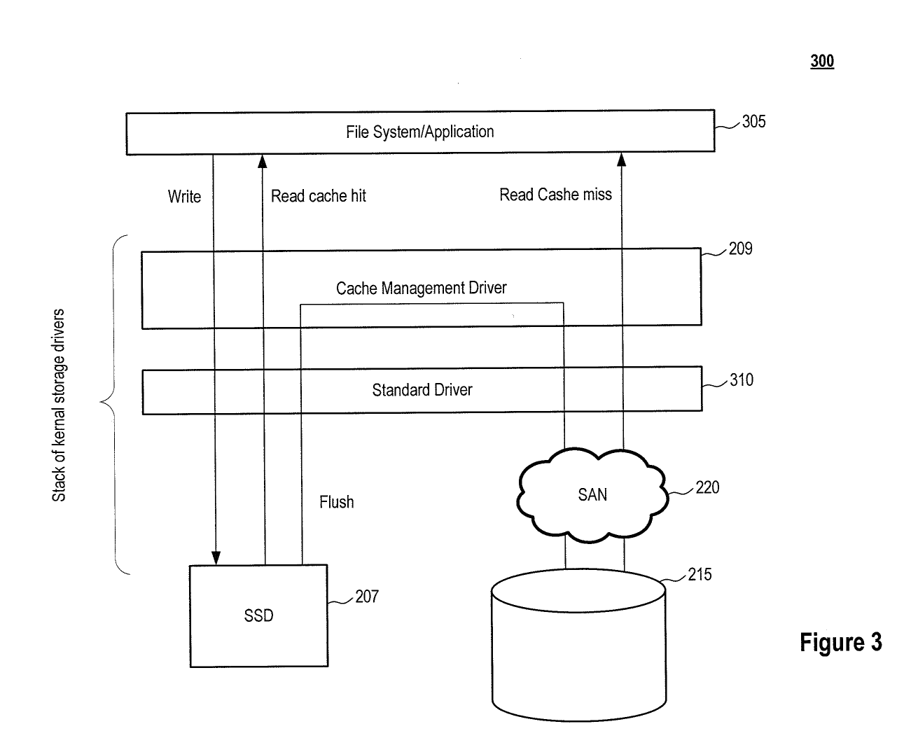

In some examples, the executable instructions for cache management 209 and 219 may be implemented as one or more block level filter drivers (or block devices). An example of a block level filter driver 300 is shown in FIG. 3, where the executable instructions 209 implement a cache management driver for persistent memory management. The cache management driver may receive read and write commands from a file system or other application 305. Referring back to FIG. 2, the cache management driver 209 may redirect write requests to the SSD 207 and acknowledge write request completion. In the case of read cache hits, the cache management driver 209 may redirect read requests to the SSD 207 and return read cached data from the SSD 207. Data associated with read cache misses, however, may be returned from the storage device 215. The cache management driver 209 may also facilitate the flushing of data from the SSD 207 onto the storage media 215. Referring back to FIG. 3, the cache management driver 209 may interface with standard drivers 310 for communication with the SSD 207 and storage media 215. Any suitable standard drivers 310 may be used to interface with the SSD 207 and storage media 215. Placing the cache management driver 209 between the file system or application 305 and the standard drivers 310 may advantageously allow for manipulation of read and write commands at a block level but above the volume manager. The volume manager is used to provide virtualization of storage media 215. That is, the cache management driver 209 may operate at a volume level, instead of a disk level. However, in some embodiments, the cache management driver 209 may communicate with a file system and provide performance acceleration with file granularity. It may be used successfully for virtualized servers that use files as virtual machines' virtual disks.

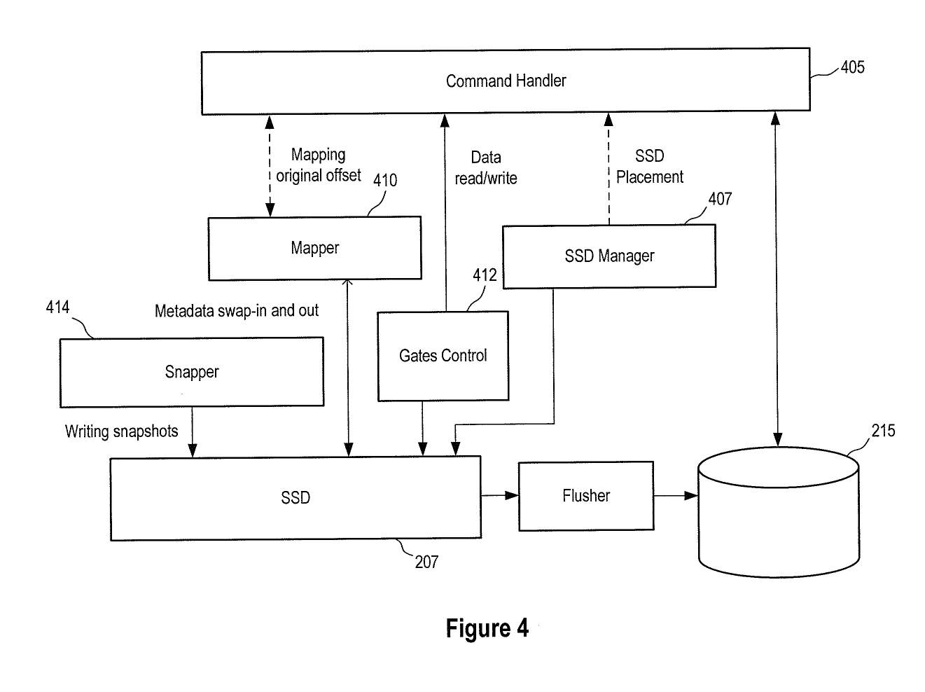

The cache management driver 209 may be implemented using any number of functional blocks, as shown in FIG. 4. The functional blocks shown in FIG. 4 may be implemented in software, firmware, or combinations thereof, and in some examples not all blocks may be used, and some blocks may be combined in some examples. The cache management driver 209 may generally include a command handler 405 that may receive read/write or management (typically called IOCTL) commands and provides communication with the platform operating system. A SSD manager 407 may control data and metadata layout within the SSD 207. The data written to the SSD 207 may advantageously be stored and managed in a log structured cache format, as will be described further below. A mapper 410 may map original requested storage media 215 offsets into offsets for the SSD 207. A gates control block 412 may be provided in some examples to gate read and writes to the SSD 207, as will be described further below. The gates control block 412 may advantageously allow the cache management driver 209 to send a particular number of read or write commands during a given time frame that may allow increased performance of the SSD 207, as will be described further below. In some examples, the SSD 207 may be associated with an optimal number of read or write requests, and the gates control block 412 may allow the number of consecutive read or write requests to be specified. It also provides write coalescing for writing to the SSD. A snapper 414 may be provided to generate periodic snapshots of metadata stored on the SSD 207. The snapshots may be useful in crash recovery, as will be described further below. A flusher 418 may be provided to flush data from the SSD 207 onto other storage media 215, as will be described further below.

The above description has provided an overview of systems utilizing a local cache media in one or more computing devices that may accelerate access to storage media. By utilizing a local cache media, such as an SSD, input/output performance of other storage media may be effectively increased when the input/output performance of the local cache media is greater than that of the other storage media as a whole. Solid state drives may advantageously be used to implement the local cache media. There may be a variety of challenges in implementing a local cache with an SSD, and the challenges may be addressed in embodiments of the invention.

While not limiting any of the embodiments of the present invention to those solving any or all of the described challenges, some challenges will nonetheless now be discussed to aid in understanding of embodiments of the invention. SSDs may have relatively high random write performance. In addition, random writes may cause data fragmentation and increase an amount of metadata that the SSD should manage internally that typically forces time consuming garbage collection procedure. That is, writing to random locations on an SSD may provide a lower level of performance than writes to contiguous locations. Embodiments of the present invention may accordingly provide a mechanism for increasing a number of contiguous writes to the SSD (or even switching completely to sequential writes in some embodiments), such as by utilizing a log structured cache, as described further below. Moreover, cache management techniques, software, and systems described herein may help SSDs advantageously improve wear leveling to avoid frequent erasing of managing block (called sometimes “erasable block”). That is, a particular location on an SSD may only be reliable for a certain number of erases. If a particular location is erased too frequently, it may lead to an unexpected loss of data. Accordingly, embodiments of the present invention may provide mechanisms to ensure data is written throughout the SSD relatively evenly, and write hot spots reduced. Still further, large SSDs (which may contain hundreds of GBs or even several TBs of data in some examples), may be associated with correspondingly large amounts of metadata that describes SSD content. While metadata for storage devices are typically stored in system memory for fast access, for embodiments of the present invention, the metadata may be too large to be practically stored in system memory. Accordingly, some embodiments of the present invention may employ multi-level metadata structures as described below and may store “cold” metadata on the SSD only as described further below. More frequently used metadata may still be stored in system memory in some examples. Referring back to FIG. 2, the computer readable media 208 may, in some examples, be the system memory and may store both more frequently used metadata and the executable instructions for cache management. Still further, data stored on the SSD local cache should be recoverable following a system crash. Furthermore, data should be restored relatively quickly. Crash recovery techniques implemented in embodiments of the present invention are described further below.

For ease of understanding, aspects of embodiments of the present invention will now be described further below arranged into sections. While sections are employed and section headings may be used, it is to be understood that information pertaining to each labeled section may be found throughout this description, and the section headings are used for convenience only. Further, embodiments of the present invention may employ different combinations of the described aspects, and each aspect may not be included in every embodiment.

Log Structured Cache

Embodiments of the present invention structure data stored in cache storage devices as a log structured cache. That is, the cache storage device may function to other system components as a cache, while being structured as a log—e.g. data and metadata are written to the cache storage device mostly or completely as a sequential stream. In this manner, the cache storage device may be used as a circular buffer. Furthermore, using SSD as a circular buffer may allow a caching driver to use standard TRIM commands and instruct SSD to start erasing a specific portion of SSD space. It may allow SSD vendors in some examples to eliminate over-provisioning of SSD space and increase amount of active SSD space. In other words, examples of the present invention can be used as a single point of metadata management that reduce or nearly eliminate the necessity of SSD internal metadata management.

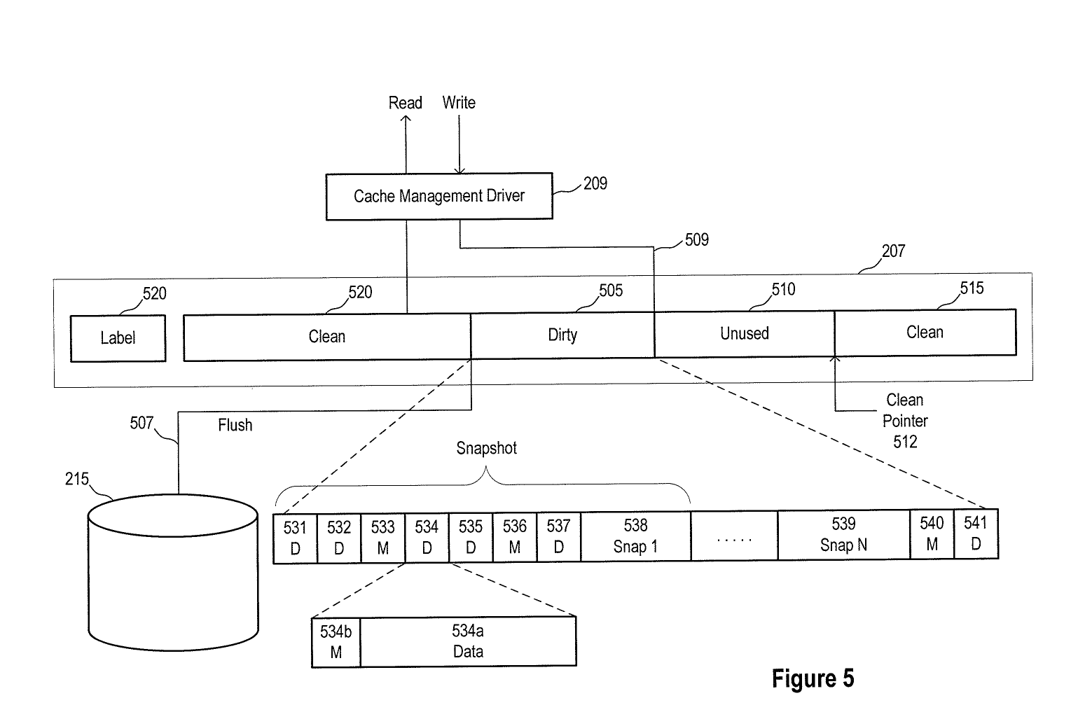

FIG. 5 is a schematic illustration of a log structured cache configuration in accordance with an example of the present invention. The cache management driver 209 is illustrated which, as described above, may receive read and write requests. The SSD 207 stores data and attached metadata in a log that includes a dirty region 505, an unused region 510, and clean regions 515 and 520. Because the SSD 207 may be used as a circular buffer, any region can be divided over the SSD 207 end boundary. In this example it is the clean regions 515 and 520 that may be considered contiguous regions that ‘wrap around’. Data stored in the log structured cache may include data corresponding to both write and read caches in some examples. The write and read caches may accordingly share a same circular buffer on a caching device in some embodiments, and write and read data may be intermingled in the log structured cache. In other embodiments, the write and read caches may be maintained separately in separate circular buffers, either on the same caching device or on separate caching devices. Accordingly, both data that is to be written to storage media may be cached in the SSD as well as frequently read data.

The dirty region may contain combined data that belongs to read and write caches. Write data in the dirty region 505 corresponds to data stored on the SSD 207 but not flushed on the storage media 215 that the SSD 207 may be accelerating. That is, the write data in the dirty region 505 has not yet been flushed to the storage media 215. The dirty data region 505 has a beginning designated by a flush pointer 507 and an end designated by a write pointer 509. The unused region 510 represents data that may be overwritten with new data. The dirty region may also be used as a read cache. A caching driver may maintain a history of all read requests. It may then recognize and save more frequently read data in SSD. That is, once a history of read requests indicates a particular data region has been read a threshold number of times, the particular data region may be placed in SSD. An end of the unused region 510 may be delineated by a clean pointer 512. The clean regions 515 and 520 contain valid data that has been flushed to the storage media 215 or belongs to read cache. Clean data may be viewed as a read cache and may be used for read acceleration. That is, data in the clean regions 515 and 520 is stored both on the SSD 207 and the storage media 215. The beginning of the clean region is delineated by the clean pointer 512, and the end of the clean region is delineated by the flush pointer 507. The current address of all described pointers may be stored in a storage location accessible to the cache management driver.

During operation, incoming write requests are written to a location of the SSD 207 indicated by the write pointer 509, and the write pointer is incremented to a next location. In this manner, writes to the SSD may be made consecutively. That is, write requests may be received by the cache management driver 209 that are directed to non-contiguous storage 215 locations. The cache management driver 209 may nonetheless directs the write request to a consecutive location in the SSD 207 as indicated by the write pointer. In this manner, contiguous writes may be maintained despite non-contiguous write requests being issued by a file system or other applications.

Data from the SSD 207 is flushed to the storage media 215 from a location indicated by the flush pointer 507, and the flush pointer incremented. The data may be flushed in accordance with any of a variety of flush strategies. In some embodiments, data is flushed after reordering, coalescing and write cancellation. The data may be flushed in strict order of its location in accelerating storage media. Later and asynchronously from flushing, data is invalidated at a location indicated by the clean pointer 512, and the clean pointer incremented keeping unused region contiguous. In this manner, the regions shown in FIG. 5 may be continuously incrementing during system operation. A size of the dirty region 505 and unused region 510 may be specified as one or more caching parameters such that a sufficient amount of unused space is supplied to satisfy incoming write requests, and the dirty region is sufficiently sized to reduce an amount of data that has not yet been flushed to the storage media 215.

Incoming read requests may be evaluated to identify whether the requested data resides in the SSD 207 at either a dirty region 505 or a clean region 515 and 520. The use of metadata may facilitate resolution of the read requests, as will be described further below. Read requests to locations in the clean regions 515, 520 or dirty region 505 cause data to be returned from those locations of the SSD, which is faster than returning the data from the storage media 215. In this manner, read requests may be accelerated by the use of cache management driver 209 and the SSD 207. Also in some embodiments, frequently read data may be retained in the SSD 207. Frequently requested data may be retained in the SSD 207 even following invalidation. The frequently requested data may be invalidated and moved to a location indicated by the write pointer 509. In this manner, the frequently requested data is retained in the cache and may receive the benefit of improved read performance, but the circular method of writing in SSD may be maintained.

As a result, writes to non-contiguous locations issued by a file system or application to the cache management driver 209 may be coalesced and converted into sequential writes to the SSD 207. This may reduce the impact of the relatively poor random write performance with the SSD 207. The circular nature of the operation of the log structured cache described above may also advantageously provide wear leveling in the SSD.

However, in some embodiments write data can overwrite previous dirty (not flushed) version of the same data. This may improve SSD space utilization but may require efficient random writes execution in SSD internally.

Accordingly, embodiments of a log structured cache have been described above. Examples of data structures stored in the log structured cache will now be described with further reference to FIG. 5. The log structured cache may take up all or any portion of the SSD 207. The SSD may also store a label 520 for the log structured cache. The label 520 may include administrative data including, but not limited to, a signature, a machine ID, and a version. The label 520 may also include a configuration record identifying a location of a last valid data snapshot. Snapshots may be used in crash recovery, and will be described further below. The label 520 may further include a volume table having information about data volumes accelerated by the cache management driver 209, such as the storage media 215. It may also include a pointer at least recent snapshots and other information that may help to restore metadata at reboot time. The cache management driver 209 may accelerate more than one storage volume. Write requests received by the cache management driver 209 may be coalesced and written in one shot to the SSD. In this manner, data for multiple volumes may be written in one transaction to the caching device.

Data records stored in the dirty region 505 are illustrated in greater detail in FIG. 5. In particular, data records 531-541 are shown. Data records associated with data are indicated with a “D” label in FIG. 5. Records associated with metadata map pages, which will be described further below, are indicated with an “M” label in FIG. 5. Records associated with snapshots are indicated with a “Snap” label in FIG. 5. Each record has associated metadata stored along with the record, typically at the beginning of the record. For example, an expanded view of data record 534 is shown a data portion 534a and a metadata portion 534b. The metadata portion 534b includes information which may identify the data and may be used, for example, for recovery following a system crash. The metadata portion 534b may include, but is not limited to, any or all of a volume offset, length of the corresponding data, and a volume unique ID of the volume the corresponding data belongs to. The data and associated metadata may be written to the SSD as a single transaction. Furthermore, a single metadata block can describe several coalesced write requests that even may belong to different accelerating volumes. That is, the metadata may contain data pertaining to different storage volumes for which the SSD is acting as a cache. Data may be written to the SSD by the cache management driver in transactions having varying sizes. Writing data with variable size as well as integration of data and metadata in single write request may significantly reduce SSD fragmentation in some examples and may also reduce a number of SSD write requests required.

Snapshots, such as the snapshots 538 and 539 shown in FIG. 5, may include metadata from each data record written since the previous snapshot. Snapshots may be written with any of a variety of frequencies. In some examples, a snapshot may be written following a particular number of data writes or following a particular amount of data written, for example. In some examples, a snapshot may be written following an amount of elapsed time. Other frequencies and reasons may also be used (for example, writing snapshot upon system graceful shutdown). By storing snapshots, recovery time after crash may advantageously be shortened in some embodiments. In some examples, each snapshot may contain a map tree, described further below, and dirty map pages that have been modified since the last snapshot. Reading the snapshot following a crash recovery may eliminate or reduce a need to read a massive number of data records from the SSD 207. Instead, mat may be recovered on the basis of snapshot. During a recovery operation, a last valid snapshot may be read to recover the map-tree at the time of the last snapshot. Then, data records written after the snapshot may be individually read, and the map tree modified in accordance with the data records to result in an accurate map tree following recovery.

Note, in FIG. 5, that metadata and snapshots may also be written to the SSD in a continuous manner along with data records to the SSD 207. This may allow for improved write performance by decreasing a number of writes and level of fragmentation and reduce the concern of wear leveling in some embodiments.

A log structured cache may allow the use of ATA TRIM commands very efficiently in some examples. A caching driver may send one or more TRIM commands to the SSD when an appropriate amount of clean data is turned into unused (invalid) data. This may advantageously simplify SSD internal metadata management and improve wear leveling in some embodiments. Also it may fully eliminates or reduce over-provisioning of SSD space needed for acceleration of random writes execution.

Accordingly, embodiments of log structured caches have been described above that may advantageously be used in SSDs serving as intermediate disk caches. The log structured cache may advantageously provide for continuous write operations and may reduce incidents of losing data because of wear leveling. When data is requested by the file system or other application using a logical address, it may be located in the SSD 207 or storage media 215. The actual data location is identified with reference to the metadata. Embodiments of metadata management in accordance with the present invention will now be described in greater detail.

Multi-Level Metadata Management

Embodiments of metadata management or mapping described herein generally provide offset translation between original storage media offsets (which may be used by a file system or other application) and actual offsets in a caching device. As generally described above, when an SSD is utilized as a cache the cache size may be quite large (hundreds of GBs or more). The size may be substantially larger than traditional (typically in-memory) cache sizes. Accordingly, it may not be feasible or desirable to maintain all mapping information in system memory. Accordingly, some embodiments of the present invention may provide multi-level metadata management in which some of the mapping information is stored in the system memory, but some of the mapping information is itself cached and saved persistently in SSD.

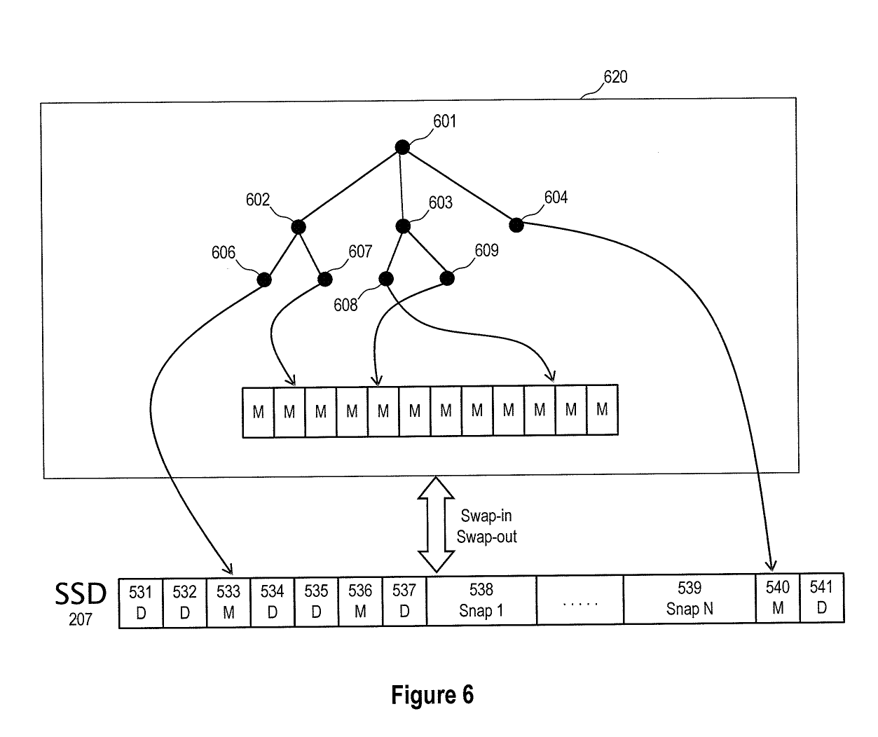

FIG. 6 is a schematic illustration of stored mapping information in accordance with examples of the present invention. The mapping may describe how to convert a received storage media offset from a file system or other application into an offset for a large cache, such as the SSD 207 of FIG. 2. An upper level of the mapping information (called map tree) may be implemented as some form of a balanced tree (an RB-tree, for example), as is generally known in the art, where the length of all branches is relatively equal to maintain predictable access time. As shown in FIG. 6, the map tree may a first node 601 which is used as a root for searching. Each node of the tree (602, 603, 604 . . . ) points to a metadata page (called map pages) located in the memory or in SSD. Each map page represents specific region in storage media and is used for searching in map tree. The boundaries between regions are flexible. As mentioned above, each node points one and only one map page. Map pages provide a final mapping between specific storage media offsets and SSD offsets. The map tree is generally stored on a system memory 620. Nodes point to map pages that are themselves stored in the system memory or may contain a pointer to a map page stored elsewhere (in the case, for example, of swapped-out pages), such as in the SSD 207 of FIG. 2. In this manner, not all map pages are stored in the system memory 620. As shown in FIG. 6, the node 606 contains a pointer to the record 533 in the SSD 207. The node 604 contains a pointer to the record 540 in the SSD 207. However, the nodes 607, 608, and 609 contain pointers to mapping information in the system memory. In some examples, the map pages stored in the system memory may also be stored in the SSD 207. Such map pages are called ‘clean’ in contrast to ‘dirty’ map pages that do not have a persistent copy in the SSD 207.

During operation, a software process or firmware, such as the mapper 410 of FIG. 4, may receive a storage media offset associated with an original command from a file system or other application. The mapper 410 may consult a map tree in the system memory 620 to determine an SSD offset for the memory command. The tree may either point to the requested mapping information stored in the system memory itself, or to a map page record stored in the SSD 207. The map page may not be present in metadata cache, and must be loaded first. Reading the map page into the metadata cache may take longer, accordingly frequently used map pages may advantageously be stored in the system memory 620. In some embodiments, the mapper 410 may track which map pages are most frequently used, and may prevent the most or more frequently used map pages from being swapped out. In accordance with the log structured cache configuration described above, map pages written to the SSD 207 may be written to a continuous location specified by the write pointer 509 of FIG. 5.

Accordingly, embodiments of multilevel mapping have been described above. Keeping “hot” (more frequently) used map pages in system memory, access time for referencing those cached map pages may advantageously be reduced. By storing other (“cold”) of the map pages in the SSD 207 or other local cache device, the amount of system memory storing metadata may advantageously be reduced. In this manner, metadata associated with a large capacity of caching device (hundreds of gigabytes in some examples) may be efficiently managed.

Read and Write Gating

Examples of the present invention utilize SSDs as a log structured cache, as has been described above. However, many SSDs have preferred input/output characteristics, such as a preferred number or range of numbers of concurrent reads or writes or both. For example, flash devices manufactured by different manufacturers may have different performance characteristics such as a preferred number of reads in progress that may deliver improved read performance, or a preferred number of writes in progress that may deliver improved write performance. Further, it may be advantageous to separate reads and writes to improve performance of the SSD and also in some examples to coalesce write data being written in the SSD. Embodiments of the described gating techniques may allow natural coalescing of write data which may improve SSD utilization. Accordingly, embodiments of the present invention may provide read and write gating functionalities that allow exploitation of the input/output characteristics of particular SSDs.

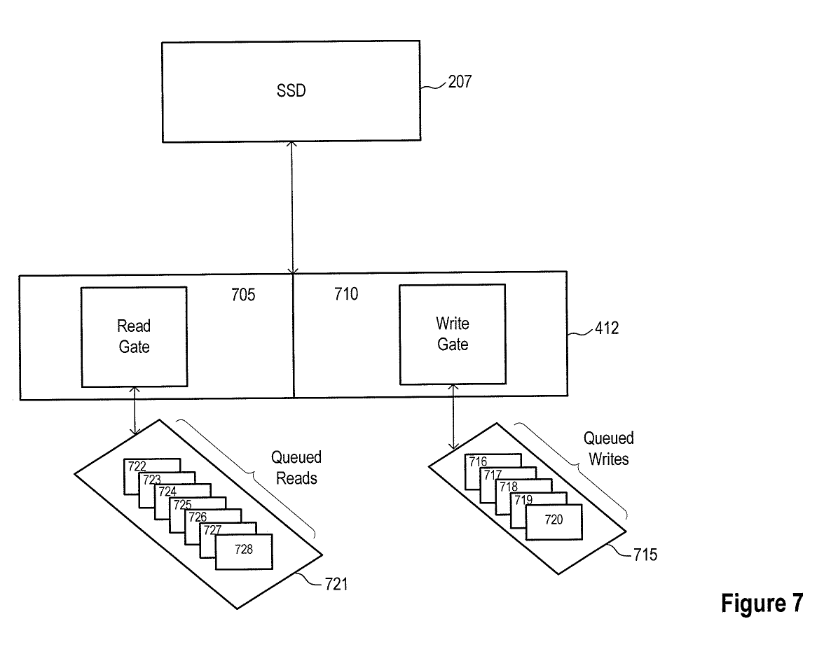

Referring back to FIG. 4, a gates control block 412 may be included in the cache management driver 209. The gates may be implemented in hardware, firmware, software, or combinations thereof. FIG. 7 is a schematic illustration of a gates control block 412 and related components arranged in accordance with an example of the present invention. The gates control block 412 may include a read gate 705, a write gate 710, or both. The write gate 710 may be in communication with or coupled to a write queue 715. The write queue 715 may store any number of queued write commands, such as the write commands 716-720. The read gate 705 may be in communication with or coupled to a read queue 721. The read queue may store any number of queued read commands, such as the read commands 722-728. The write and read queues may be implemented generally in any manner, including being stored on the computer system memory, for example.

In operation, incoming write and read requests from a file system or other application or from the cache management driver itself (such as reading data from SSD for a flushing procedure) may be queued in the read and write queues 721 and 715. The gates control block 412 may receive an indication—when gates should be opened and for how long gates should be kept opened. The timing of the indication may depend on specific SSD performance characteristics. For example, an optimal number or range of ongoing writes or reads may be specified. The gates control block 412 may be configured to open either the read gate 705 or the write gate 710 at any one time, but not allow both writes and reads to occur simultaneously in some examples. Moreover, the gates control block 412 may be configured to allow a particular number of concurrent writes or reads in accordance with the performance characteristics of the SSD 207.

In this manner, embodiments of the present invention may avoid the mixing of read and write requests to an SSD functioning as a cache for another storage media. Although a file system or other application may provide a mix of read and write commands, the gates control block 412 may ‘un-mix’ the commands by queuing them and allowing only writes or reads to proceed at a given time, in some examples. Finally, queuing write commands may enable write coalescing that may improve overall SSD 207 usage (the bigger the write block size, the better the throughput that can generally be achieved in SSD).

In some embodiments, SSDs as described herein may be used to accelerate disk-based storage media. That is, as described above, making use of caching devices, such as SSDs improves access to another storage media. In these embodiments, as has been described above, volume IDs and location on the volume, such as offsets, are used for searching for data in the SSD. In these embodiments the storage media may typically be available as direct attached storage or over a storage area network, although other attachments are possible. Multi-level metadata management may be used to implement this. However, other types of searching may be used in other embodiments. For example, other keys besides volume ID and location may be used to identify stored data. In some embodiments, data may be stored as binary large objects (BLOBs). A BLOB identifier, such as a key, may be used for data identification and searching in the SSD cache. In this manner, caching devices described herein may serve as caches for abstract objects. In other embodiments, the caching devices described herein may be used to accelerate a file system and data may be stored as files or directories. In these embodiments, the storage media to be accelerated may typically be a local storage media or available over network attached storage, although other attachments are possible.

From the foregoing it will be appreciated that, although specific embodiments of the invention have been described herein for purposes of illustration, various modifications may be made without deviating from the spirit and scope of the present invention.

What is claimed is:

1. A method comprising:
caching data from a storage medium in a solid state device, wherein the solid state storage device is configured to store data in a log structured cache format, wherein the log structured cache format is configured to provide a circular buffer on the solid state storage device.

2. The method of claim 1, wherein the circular buffer is configured to receive data at one end of the circular buffer and to flush data from another end of the circular buffer onto the storage medium.

3. The method of claim 1, further comprising writing data to the solid state device in blocks having variable size.

4. The method of claim 1, further comprising periodically flushing data from one end of the circular buffer onto the storage medium.

5. The method of claim 1, wherein the solid state device is configured to cache data from a plurality of storage media volumes in the circular buffer.

6. The method of claim 1, wherein the circular buffer is configured such that data to be flushed to the storage media is located at one end of the circular buffer.

7. The method of claim 1, wherein the circular buffer includes data for both a write and a read cache.

8. The method of claim 1, further comprising receiving write requests corresponding to non-contiguous storage locations; and
writing write data associated with the write requests to contiguous locations in the solid state device.

9. The method of claim 1, further comprising writing metadata associated with cached data to a contiguous location of the circular buffer with the cached data.

10. The method of claim 9, further comprising writing the data and the metadata to the solid state device in a single transaction.

11. The method of claim 9 further comprising writing a snapshot of metadata to the solid state device, wherein the snapshot of metadata is associated with each of a plurality of data blocks written since a previous snapshot.

12. The method of claim 9, wherein the metadata comprises a volume location, a length of the data, a volume ID of the data, or combinations thereof.

13. The method of claim 1, wherein the circular buffer is configured to identify data using a key.

14. The method of claim 1, further comprising:
storing a map tree in a system memory, wherein nodes of the map tree point to map pages;
storing less frequently used map pages in the solid state device; and
storing more frequently used map pages in a system memory.

15. The method of claim 1, further comprising receiving a plurality of intermingled read and write requests;
queuing the read requests in a first queue;
queuing the write requests in a second queue; and
allowing only read requests or write requests to be serviced at a time.

16. The method of claim 14, further comprising allowing only a predetermined number of read requests or write requests to be serviced at a time.

17. The method of claim 15, wherein the predetermined number is based, at least in part, on properties of the solid state device.

18. The method of claim 1, wherein the storage media comprises direct attached storage.

19. The method of claim 1, wherein the storage media comprises media accessible over a storage area network.

20. The method of claim 1, wherein the solid state device comprises a direct attached solid state device.

21. The method of claim 1, wherein the solid state device is accessible over a storage area network.

22. The method of claim 1, wherein the log structured cache format comprises:
a dirty region corresponding to data stored on the solid state storage device but not flushed to the storage medium, wherein a start of the dirty region is delineated by a flush pointer;
an unused region corresponding a region for writing new data, wherein a start of the unused region is delineated by a write pointer and an end of the unused region is delineated by a clean pointer; and
a clean region corresponding to data that has been flushed to the storage media, wherein a start of the clean region is delineated by the clean pointer and an end of the clean region is delineated by the flush pointer.

23. The method of claim 22, wherein the method further comprises:
writing data, responsive to a write request, to a location of the solid state storage device indicated by the write pointer; and
incrementing the write pointer to a consecutive location.

24. The method of claim 23, wherein the write request is a first write request corresponding to a first location of the storage media, the method further comprising receiving a second write request corresponding to a second location of the storage media, wherein the first and second locations are non-contiguous, and wherein the method further comprises:
writing data, responsive to the second write request, to the consecutive location indicated by the write pointer.

25. The method of claim 1, further comprising:
receiving a read request for a first location of the storage media;
identifying data corresponding to the first location stored on the solid state storage device;
when the data is stored in the dirty region or the clean region, returning data from the solid state storage device; and
when the data is stored in the unused region, returning data from the storage media.

26. At least one non-transitory computer readable medium encoded with instructions that, when executed, cause a computer system to perform operations including:
caching data from a storage media accessible over a storage area network in a solid state device, wherein the local solid state storage device is configured to store data in a log structured cache format, wherein the log structured cache format is configured to provide a circular buffer on the solid state storage device.

27. The at least one non-transitory computer readable medium of claim 26, wherein the circular buffer is configured to receive data at one end of the circular buffer and to flush data from another end of the circular buffer onto the storage medium.

28. The at least one non-transitory computer readable medium of claim 26, wherein the instructions further, when executed, cause the computer system to perform operations including writing data to the solid state device in blocks having variable size.

29. The at least one non-transitory computer readable medium of claim 26, wherein the instructions further, when executed, cause the computer system to perform operations including periodically flushing data from one end of the circular buffer onto the storage medium.

30. The at least one non-transitory computer readable medium of claim 26, wherein the instructions further, when executed, cause the computer system to perform operations including caching data from a plurality of storage media volumes in the circular buffer.

31. The at least one non-transitory computer readable medium of claim 26, wherein the circular buffer is configured such that data to be flushed to the storage media is located at one end of the circular buffer.

32. The at least one non-transitory computer readable medium of claim 26, wherein the circular buffer includes data for both a write and a read cache.

33. The at least one non-transitory computer readable medium of claim 25, wherein the log structured cache format includes:
a dirty region corresponding to data stored on the solid state storage device but not flushed to the storage media, wherein a start of the dirty region is delineated by a flush pointer;
an unused region corresponding a region for writing new data, wherein a start of the unused region is delineated by a write pointer and an end of the unused region is delineated by a clean pointer; and
a clean region corresponding to data that has been flushed to the storage media, wherein a start of the clean region is delineated by the clean pointer and an end of the clean region is delineated by the flush pointer; and
wherein the instructions further, when executed, cause the computer system to perform operations including:
writing data, responsive to a write request, to a location of the solid state storage device indicated by the write pointer; and
incrementing the write pointer to a consecutive location.

34. The at least one non-transitory computer readable medium of claim 26, wherein the operations further comprise, writing metadata associated with the data to a contiguous location with the data.

35. The at least one non-transitory computer readable medium of claim 34, wherein the data and the metadata are written in a single transaction.

36. A computer system comprising:
a processing unit;
a local solid state storage device configured to provide a cache of data stored on storage device accessible via a storage area network, wherein the local solid state storage device is configured to store data in a log structured cache format, wherein the log structured cache format is configured to provide a circular buffer on the solid state storage device.

37. The computer system of claim 32 further comprising:
a computer readable media encoded with executable instructions, at least some configured for execution by the processing unit, that cause the computer system to perform operations comprising receiving data at one end of the circular buffer and flushing data from another end of the circular buffer onto the storage medium.

38. The computer system of claim 36, wherein the executable instructions further, when executed, cause the computer system to perform operations including writing data to the solid state device in blocks having variable size.

39. The computer system of claim 36 wherein the log structured cache format includes:
a dirty region corresponding to data stored on the solid state storage device but not flushed to the storage media, wherein a start of the dirty region is delineated by a flush pointer;
an unused region corresponding a region for writing new data, wherein a start of the unused region is delineated by a write pointer and an end of the unused region is delineated by a clean pointer; and
a clean region corresponding to data that has been flushed to the storage media, wherein a start of the clean region is delineated by the clean pointer and an end of the clean region is delineated by the flush pointer; and
wherein the computer system further comprises:
a computer readable media encoded with executable instructions, at least some configured for execution by the processing unit, that cause the computer system to perform operations comprising:
writing data, responsive to a write request, to a location of the solid state storage device indicated by the write pointer; and
incrementing the write pointer to a consecutive location

40. The computer system of claim 36, wherein the solid state storage device comprises a flash drive.
